(19) United States
(12) Patent Application Publication
(10) Pub. No.: US 2013/0130797 A1
(43) Pub. Date: May 23, 2013

(54) Systems and methods for transforming and/or generating a tangible physical structure based on user input information

(71) Applicant: Janos Stone, Astoria, NY (US)

(72) Inventor: Janos Stone, Astoria, NY (US)

(21) Appl. No.: 13/467,713

(22) Filed: May 9, 2012

Related U.S. Application Data
(63) Continuation-in-part of application No. 13/082,192, filed on Apr. 7, 2011.
Application No. 13/082,192 is a continuation-in-part of application No. 12/862,190, filed on Aug. 24, 2010.

(51) Int. Cl. G06F 3/01

(52) U.S. Cl. CPC G06F 3/01
USPC 463/36; 715/764; 715/849

(57) ABSTRACT

A method including the steps of displaying on an input device an initial virtual object and a target virtual object; receiving by the input device user input information related to transformation of one or more characteristics of the initial virtual object; transforming, using one or more processors, the one or more characteristics of the initial virtual object from a first configuration to a second configuration based on the user input information; displaying on the input device the initial virtual object with the transformed one or more characteristics as a modified initial virtual object; and determining, using one or more processors, whether the modified initial virtual object matches the target virtual object.

### RELATED APPLICATIONS

This application is a continuation-in-part of U.S. patent application Ser. No. 13/082,192, entitled SYSTEMS AND METHODS FOR TRANSFORMING AND/OR GENERATING A TANGIBLE PHYSICAL STRUCTURE BASED ON USER INPUT INFORMATION, filed Apr. 7, 2011, which in turn is a continuation-in-part of U.S. patent application Ser. No. 12/862,190, entitled SYSTEMS AND METHODS FOR TRANSFORMING AND/OR GENERATING A TANGIBLE PHYSICAL STRUCTURE BASED ON USER INPUT INFORMATION, filed Aug. 24, 2010, the contents of which are incorporated herein by reference in their entirety.

### FIELD

The present invention relates to systems and methods for transforming a virtual object.

### SUMMARY

In exemplary embodiments, a method for transforming an object based on user input information can comprise receiving a user input alpha-numeric input information; storing, in at least one processor readable memory, the user input alpha-numeric input information and correlating, using an algorithm, the user input alpha-numeric information with at least one of shape and color transformations; and processing, using at least one processor, the alpha-numeric inputs and the algorithm to transform at least one of the shape and the color of the virtual object from a first configuration to a second configuration.

In exemplary embodiments, the method can further comprise generating, using at least one object generating system, a tangible physical object based on the second configuration of the virtual object.

In exemplary embodiments, the alpha-numeric input information can include the alpha-numeric letters A through Z of the Latin and/or Roman alphabet and/or the Arabic numerals 0 through 9.

In exemplary embodiments, the alpha-numeric input information can include alpha-numerical letters of any alphabet of any language such as, but not limited to, Greek, Russian, Hebrew, Japanese, and/or any other language.

In exemplary embodiments, each consecutive user input alpha-numeric input into the algorithm can cause consecutive transformations of the virtual object such that the previous transformation can be used in the next consecutive transformation. Further, the alpha-numeric information can be a user's name, identification, or any other marker.

In exemplary embodiments, the virtual object having a first shape can be cuboid, any three-dimensional shape capable of being manipulating using alpha-numeric inputs, and/or the three-dimensional shape can be that of a consumer product.

In exemplary embodiments, the tangible physical object can be generated using at least one of stereo-lithography, 3-D printing, and direct laser sintering.

In exemplary embodiments, the virtual object can be an avatar.

In exemplary embodiments, the new shaped physical object can be for an identification and/or pass code.

In exemplary embodiments, a system for transforming an object based on user input information can comprise a communications portal and/or a user interface for receiving a user input alpha-numeric input information; at least one processor readable memory for storing the user input alpha-numeric input information and for storing an algorithm that correlates the user input alpha-numeric input information to at least one of shape and color transformations; and at least one processor for accessing and processing the user input alpha-numeric input information and an algorithm for transforming at least one of the shape and color of the virtual object from a first configuration to a second configuration.

In exemplary embodiments, the system can further comprise at least one object generating system for generating a tangible physical object based on the second configuration of the virtual object.

In exemplary embodiments, the alpha-numeric input information can include the alpha-numeric letters A through Z of the Latin and/or Roman alphabet and/or the Arabic numerals 0 through 9.

In exemplary embodiments, each consecutive user input alpha-numeric input into the algorithm can cause consecutive transformations of the virtual object such that the previous transformation can be used in the next consecutive transformation. Further, the alpha-numeric input information can be a user's name.

In exemplary embodiments, the virtual object having a first shape can be cuboid, can be any three-dimensional shape capable of being manipulating using alpha-numeric inputs, and/or the three-dimensional shape can be that of a consumer product.

In exemplary embodiments, the at least one object generating system can further comprise a stereo-lithography machine; 3-D printing system; and/or direct metal laser sintering system.

In exemplary embodiments, the virtual object can be an avatar.

In exemplary embodiments, the new shaped physical object can be for at least one of an identification and pass code.

A method for transforming a virtual object based on user input information, comprises: receiving by an input device a user input alpha-numeric information; correlating, using one or more processors, the user input alpha-numeric information with transformation of one or more characteristics of the virtual object; and transforming, using one or more processors, the one or more characteristics of the virtual object from a first configuration to a second configuration based on the correlated user input alpha-numeric information.

A system for transforming an object based on user input information, comprises: at least one processor; at least one processor readable medium operatively connected to the at least one processor, the at least one processor readable medium having processor readable instructions executable by the at least one processor to perform the following method: receiving by an input device a user input alpha-numeric information; correlating the user input alpha-numeric information with transformation of one or more characteristics of the virtual object; and transforming the one or more characteristics of the virtual object from a first configuration to a second configuration based on the correlated user input alpha-numeric information.

In at least one exemplary embodiment, the input device is a graphical user interface.

In at least one exemplary embodiment, the graphical user interface comprises one or more of the following widgets: buttons, check boxes, radio buttons, sliders, list boxes, spinners, drop-down lists, menus, menu bars, toolbars, ribbons, combo boxes, icon, tree views, grid views, cover flows, tabs, scrollbars, text boxes, labels, tooltips, balloon help, status bars, progress bars, and infobars.

In at least one exemplary embodiment, the input device is a game controller.

In at least one exemplary embodiment, the game controller comprises one or more of the following: joysticks, gamepads, paddles, trackballs, steering wheels, pedals, or light guns. The game controllers may be directly wired or connected via a wireless connection such as WiFi, BlueTooth, RFID, to name a few.

In at least one exemplary embodiment, the one or more characteristics comprises one or more of the following characteristics: shape, color, material properties, texture, and mechanical properties.

In at least one exemplary embodiment, the method further comprises generating, using at least one object generating system, a tangible physical object based on the second configuration of the virtual object.

In at least one exemplary embodiment, the alpha-numeric input information includes at least one of the alpha-numeric letters A through Z of the Latin and Roman alphabet and the Arabic numerals 0 through 9.

In at least one exemplary embodiment, each consecutive user input alpha-numeric input causes consecutive transformations of the virtual object such that the previous transformation is used in the next consecutive transformation.

In at least one exemplary embodiment, the alpha-numeric information is a user's name.

In at least one exemplary embodiment, the virtual object has a three-dimensional shape.

In at least one exemplary embodiment, the three-dimensional shape is that of a consumer product.

In at least one exemplary embodiment, the tangible physical object is generated using at least one of stereo-lithography, 3-D printing, and direct laser sintering.

In at least one exemplary embodiment, the virtual object is an avatar.

In at least one exemplary embodiment, the physical object is for at least one of an identification and pass code.

A method according to another exemplary embodiment of the present invention includes the steps of: displaying on an input device an initial virtual object and a target virtual object; receiving by the input device user input information related to transformation of one or more characteristics of the initial virtual object; transforming, using one or more processors, the one or more characteristics of the initial virtual object from a first configuration to a second configuration based on the user input information; displaying on the input device the initial virtual object with the transformed one or more characteristics as a modified initial virtual object; and determining, using one or more processors, whether the modified initial virtual object matches the target virtual object.

### BRIEF DESCRIPTION OF THE DRAWINGS

The features and advantages of the present invention will be more fully understood with reference to the following, detailed description when taken in conjunction with the accompanying figures, wherein:

FIG. 1 is a block diagram of certain components of the systems and methods for transforming and/or generating a tangible physical structure based on user input information, in accordance with exemplary embodiments of the present invention;

FIGS. 2A-2C are illustrative depictions of various shape changes and color changes affiliated with alpha-numeric values, in accordance with exemplary embodiments of the present invention;

FIG. 3 is a flow chart illustrating transforming and/or generating a tangible physical structure based on user input information, in accordance with exemplary embodiments of the present invention;

FIG. 4 is a flow chart illustrating transforming an object based on user input information, in accordance with exemplary embodiments of the present invention;

FIGS. 5A-6B are illustrative depictions of various steps of FIG. 4 illustrating transforming an object based on user input information, in accordance with exemplary embodiments of the present invention;

FIG. 7 illustratively depicts a mobile phone transforming, in accordance with exemplary embodiments of the present invention;

FIG. 8 illustratively depicts an identification generating, in accordance with exemplary embodiments of the present invention;

FIG. 9 is a screenshot of an electronic game using the systems and methods of the various exemplary embodiments of the present invention; and

FIGS. 10A-10F show a game interface according to an exemplary embodiment of the present invention as implemented on a mobile device as a player manipulates an initial object to match a target object within the interface.

### DETAILED DESCRIPTION

The invention generally relates to systems and methods that can transform and/or generate a virtual object in first configuration to a virtual object in a second configuration based on alpha-numeric information input by a user. The virtual object can be transformed from a first configuration to a second configuration by a physical and/or virtual object transforming system “object transforming system” using an algorithm that can affiliate shape transformations, color transformations, and alpha-numeric information to alpha-numeric information input by the user. In a second configuration, the virtual object can then be generated into a tangible physical object using a tangible physical object generating system “object generating system.” In exemplary embodiments, user input need not be alpha-numeric information, but instead may be any other type of information, such as, for example, information related to direct commands to change the color, shape, skew, size or any other aspect of a virtual object, where such commands may be entered through any type of data entry device, such as, for example, a standard keyboard, a specialized keyboard, a touchscreen display, a game controller, a speech recognition interface and a virtual environment interface, to name a few. For example, in embodiments described herein in which alpha-numeric information such as a sequence of letters is input to modify a virtual object, a user may instead press a particular function key or series of function keys within a keyboard or touchscreen display to achieve the same modification.

In some instances, the virtual object may not be transformed into a physical object. For example, in a second configuration, the virtual object can remain as a virtual object that can be used as a pass code and/or identification (“identification”).

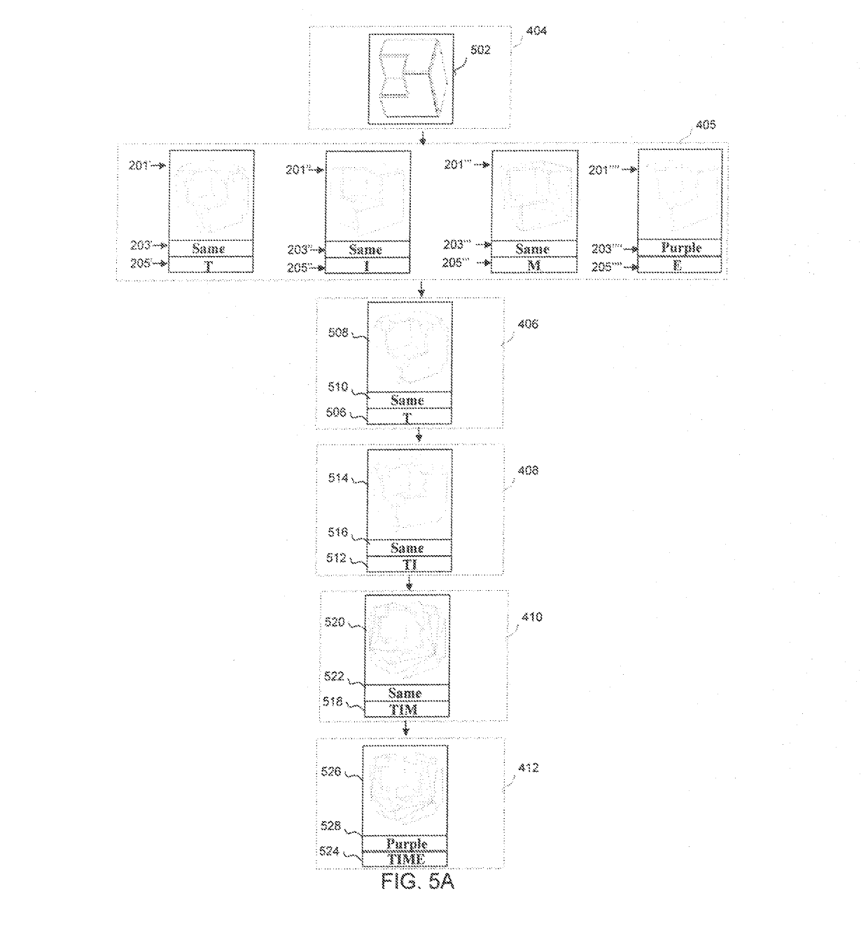

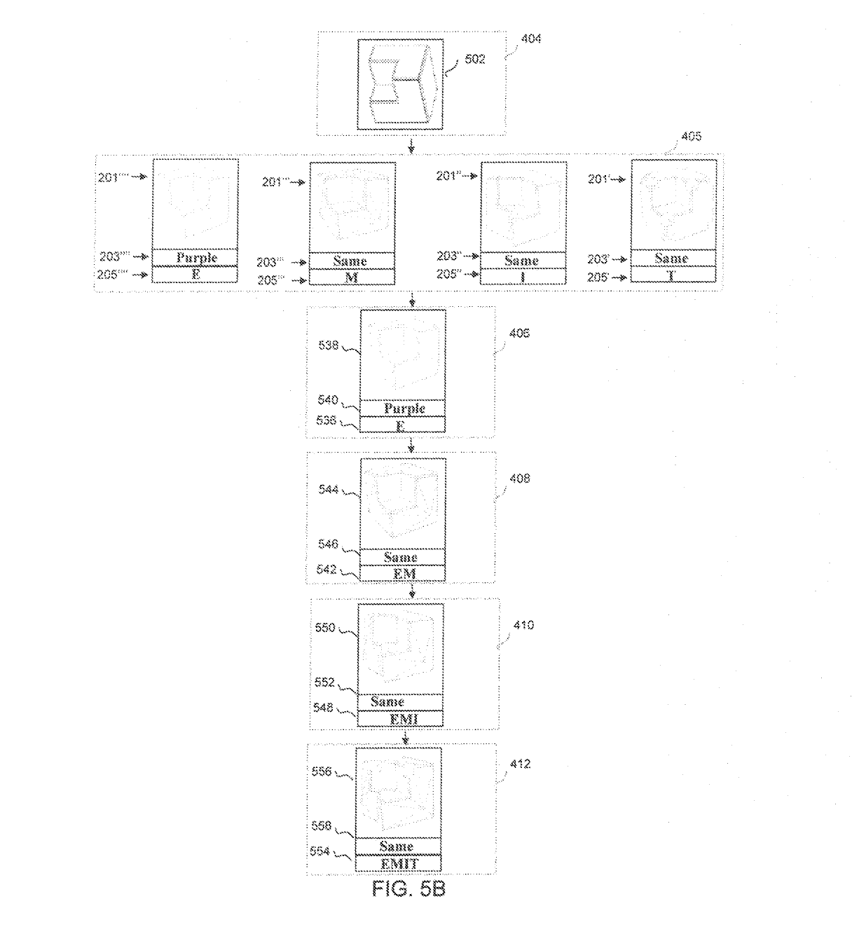

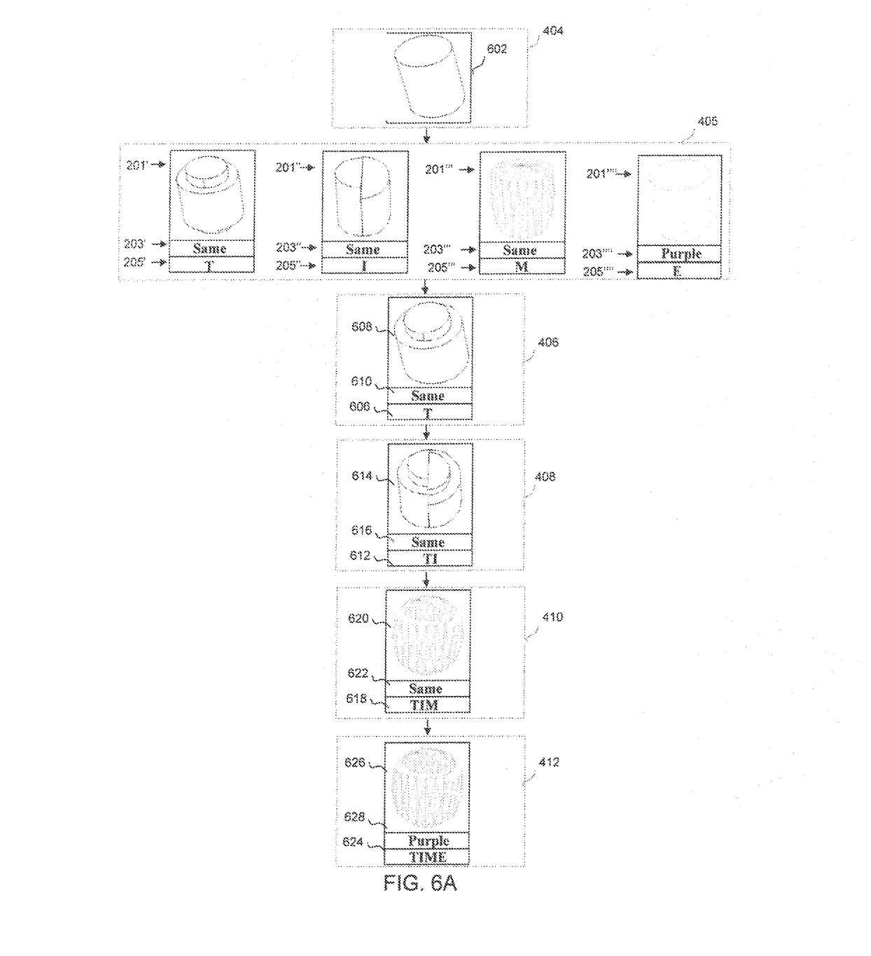

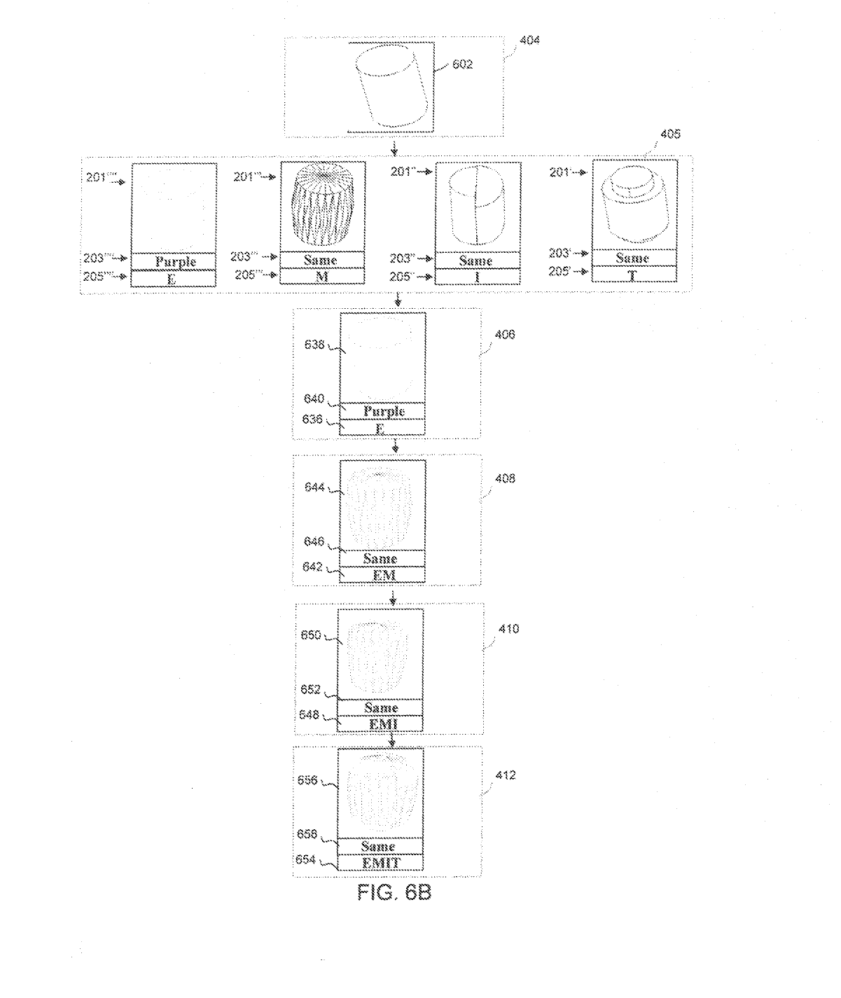

In exemplary embodiments, each alpha-numeric input can transform the shape and/or color of object such that the shape and/or color can sequentially and/or cumulatively transform based on previous inputs such that the order in which the alpha-numeric information is input can affect the shape of the object. For example, as illustrated in FIGS. 5A and 5B and in FIGS. 6A and 6B, inputting “T-I-M-E”, in some instances, may generate one shape while inputting “E-M-I-T” may generate a different shape.

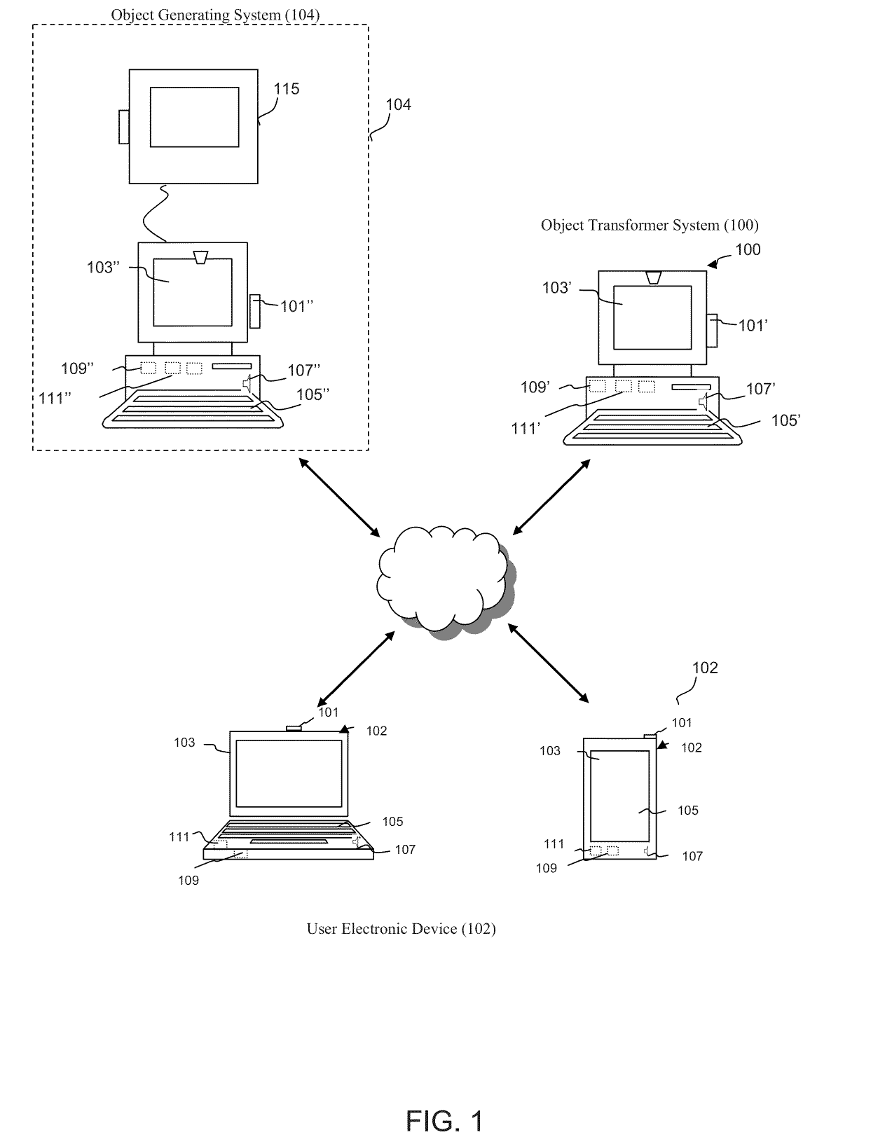

Referring to FIG. 1, object transforming system 100 can communicate at least some information affiliated with an object in a first configuration to a user, via user electronic device 102, and based on user input alpha-numeric information object transforming system 100 can transform the shape and/or color of the object to a second configuration such that object generating system 104 can produce a tangible physical object in the second configuration. The alpha-numeric information may be input by a user using keystrokes of a keyboard. However, it should be appreciated that the alpha-numeric information may be input using any suitable input device, such as, for example, a graphical user interface that includes one or more of the following types of widgets: buttons, check boxes, radio buttons, sliders, list boxes, spinners, drop-down lists, menus, menu bars, toolbars, ribbons, combo boxes, icon, tree views, grid views, cover flows, tabs, scrollbars, text boxes, labels, tooltips, balloon help, status bars, progress bars, and infobars, to name a few, and/or external input devices, such as, for example, joysticks, gamepads, paddles, trackballs, steering wheels, pedals, light guns, or other types of game controllers, to name a few. The external input devices may be directly connected or connected via a wireless connection such as WiFi, BlueTooth, RFID, to name a few.

It will be understood that any of object transforming system 100, user electronic device 102, and/or physical object generating system 104 can communicate with each other and/or can be further combined and/or separated. For ease, object transforming system 100, user electronic device 102, and/or physical object generating system 104 are, at times, shown separately. This is merely for ease and is in no way meant to be a limitation.

Further, object transforming system 100 can reside on and/or be affiliated with user electronic device 102. For example, object transforming system 100 may be a processor readable medium, such as, for example, a CD_ROM, hard disk, floppy disk, RAM or optical disk, to name a few, that includes processor-readable code that can be accessed and/or processed by a processor affiliated with user electronic device 102. Further still, object transforming system 100 can reside on and/or be affiliated with physical object generating system 104. For example, object transforming system 100 may be a processor readable medium, such as, for example, a CD-ROM, hard disk, floppy disk, RAM or optical disk, to name a few, that includes processor-readable code that can be accessed and/or processed by a processor affiliated with physical object generating system 104.

As shown, object transforming system 100, user electronic device 102, and/or physical object generating system 104 can include, but is not limited to, at least one communication portal 101, 101′, 101″; at least one graphical user interface 103, 103′, 103″; at least one user input 105, 105′, 105″; at least one speaker 107, 107′, 107″; at least one processor readable memory 109, 109′, 109″; at least one processor 111, 111′, 111″; and any other reasonable components for use in communicating information (e.g., data), storing information, and processing any form of information.

In some instances, graphical user interface 103, 103′, 103″ and user input 105, 105′, 105″ can be substantially the same. For example, graphical user interface 103, 103′, 103″ and user input 105, 105′, 105″ can be combined as a touch distribution system. The touch distribution system can be a display that can detect the presence and location of a touch within the distribution system area.

Object transforming system 100, user electronic device 102, and/or physical object generating system 104 can be, for example, a mobile phone, computer, iPad®, iPod®, iPhone®, smartphone, and BlackBerry®, to name a few.

Object transforming system 100, user electronic device 102, and/or physical object generating system 104 can include a plurality of subsystems and/or libraries, such as, but not limited to, shape transformation library subsystem, color transformation library subsystem, alpha-numeric library subsystem, and user input alpha-numeric library subsystem. Shape transformation library subsystem can include any processor readable memory capable of storing information affiliated with shape transformation and/or being accessed by any processor. Color transformation library subsystem can include any processor readable memory capable of storing information affiliated with color transformations and/or being accessed by any processor. Alpha-numeric library subsystem can include any processor readable memory capable of storing information affiliated with alpha-numeric inputs and/or being accessed by any processor.

It will be understood that any aspect of an object can be transformed, such as, but not limited to, shape, color, material properties, texture, mechanical properties, any combination thereof, and/or any aspect of the object can be transformed. Further, any combination of colors and/or color patterns can be combined. For ease, at times, only shape and/or a single color transformation is described. This is merely for ease and is in no way meant to be a limitation.

It will be understood that the alpha-numeric system can be based on Latin letters and Arabic digits and/or can be based on any writing system based on an alphabet, abjad, abugida, syllabary, logography and/or any other writing system and/or symbol affiliated with any language such as, but not limited to, English, Hebrew, Russian, Greek, Japanese, Chinese, and/or any other language and/or any numeral system such as, but not limited to, Roman numerals, Egyptian numerals, and/or any other numeral system. For ease, at times, only Latin letters and Arabic digits are described. This is merely for ease and is in no way meant to be a limitation.

In exemplary embodiments, object generating system 104 can be affiliated with and/or an element of a rapid production device 115 such as, but not limited to, a 3-D printing system, direct metal laser sintering system, selective laser sintering system (“SLS”), fused deposition modeling system (“FDM”), stereolithography system (“SLA”), laminated object manufacturing system (“LOM”), and/or any technique and/or system that can produce a tangible physical structure. This tangible physical object can be produced from any reasonable material, such as, but not limited to, thermoplastics, metals powders, eutectic metals, photopolymer, paper, titanium alloys, wood, plastics, polymers, and/or any other material capable of being used to produce a tangible physical object.

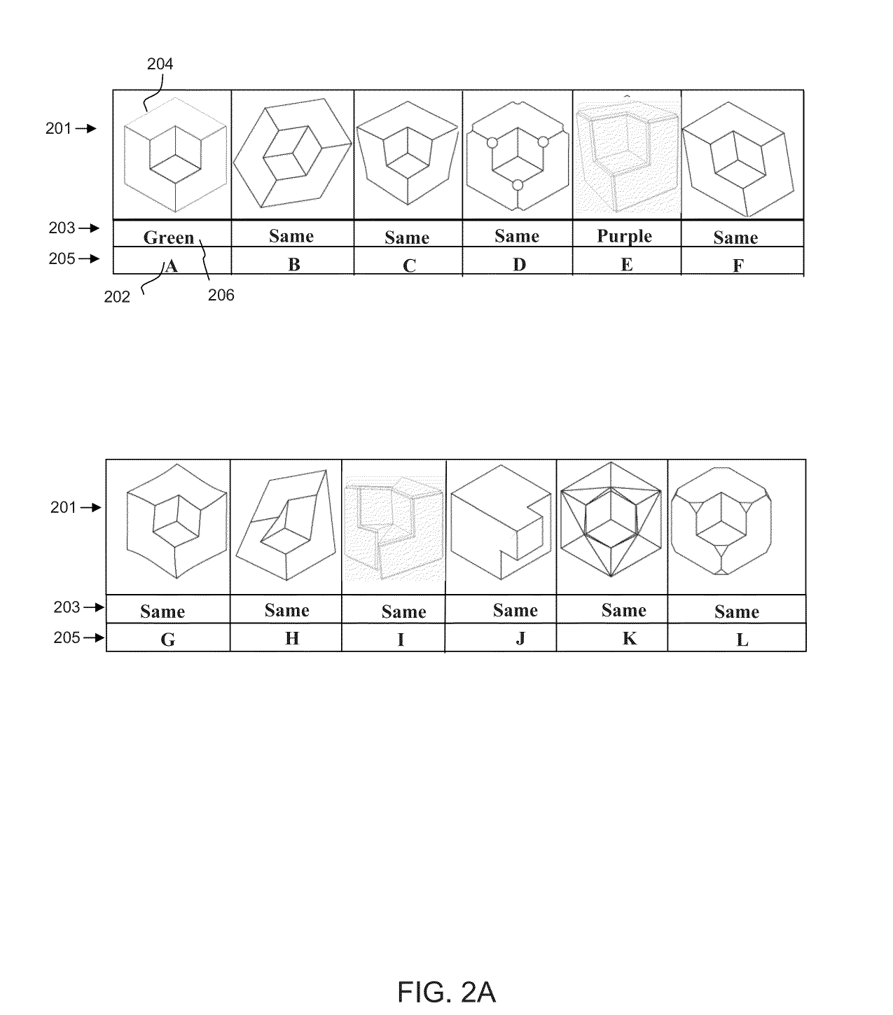

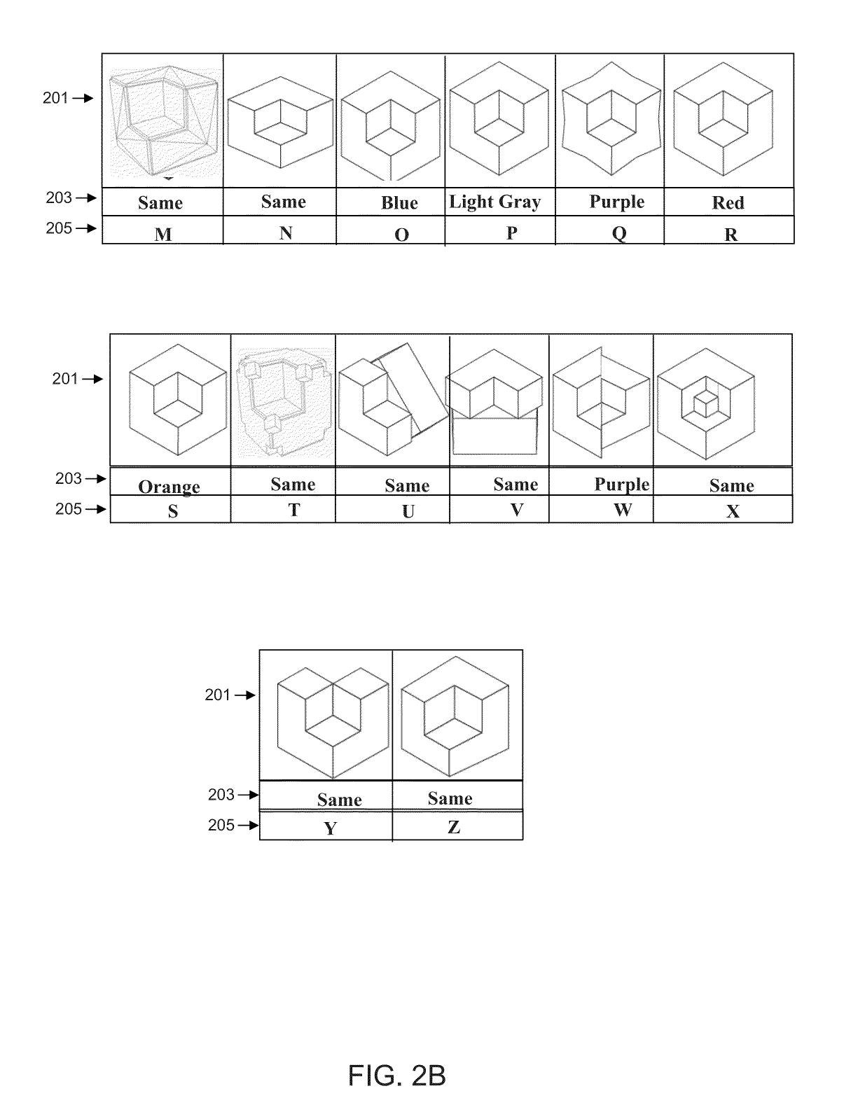

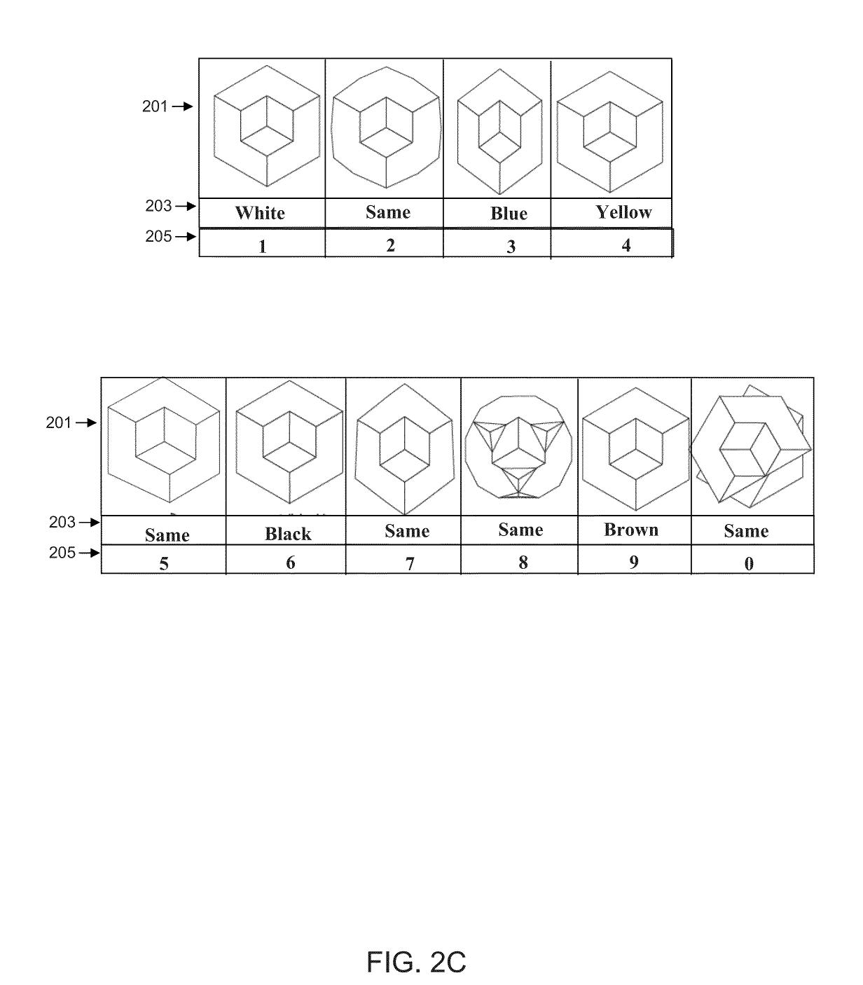

Referring to FIGS. 2A-2C, in exemplary embodiments, shape transformation information 201, color transformation information 203, and/or alpha-numeric information 205 can be affiliated with alpha-numeric information input by a user using, for example, a matching engine that uses an algorithm such that object transforming system 100 can transform the shape and/or color of an object based on alpha-numeric user inputs. As an example, the matching engine may be a processor readable medium, such as, for example, a CD_ROM, hard disk, floppy disk, RAM or optical disk, to name a few, that includes processor-readable code that can be accessed and/or processed by a processor affiliated with user electronic device 102, object transforming system 100, and/or physical object generating system 104 to perform an algorithm that affiliates alpha-numeric information “A” 202 with shape transformation information 204 and color transformation information 203. Following this affiliation, when a user inputs alpha-numeric information “A” 202 the algorithm can cause the object's color to transform to green and have the object's shape transformed to the shape depicted for shape transformation information 204.

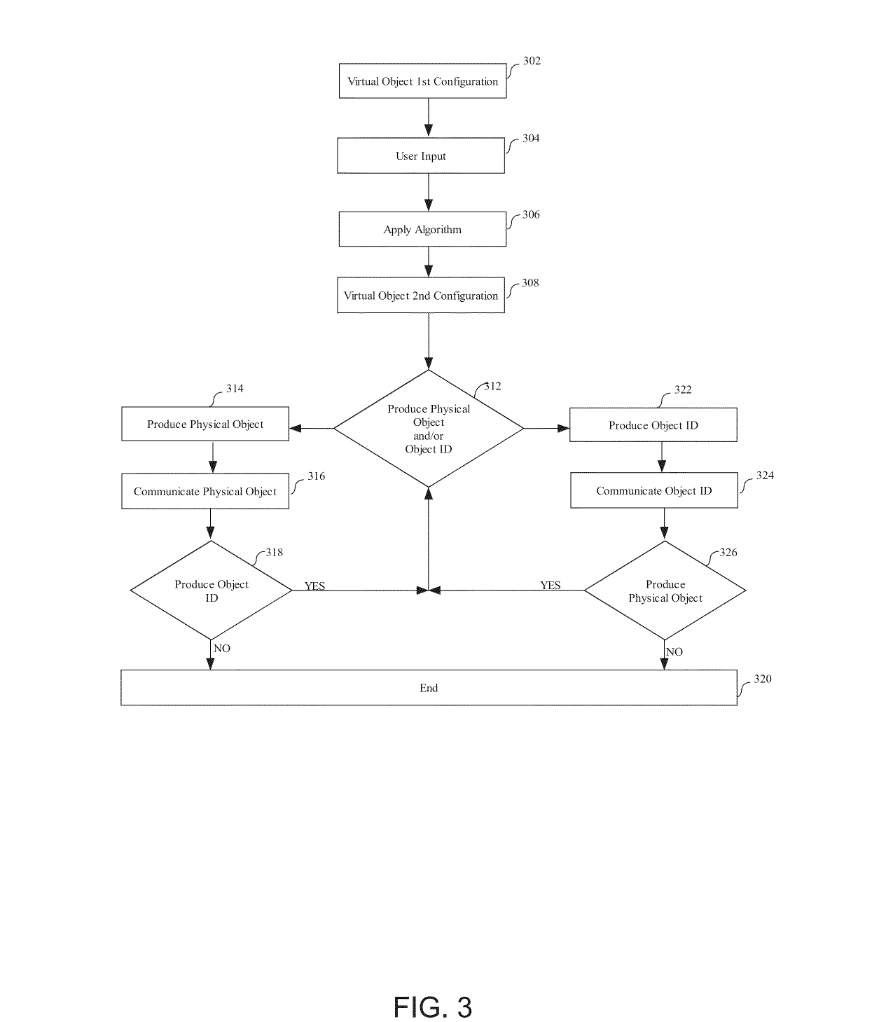

Referring to FIG. 3, in exemplary embodiments, a virtual object can be transformed from a first configuration to a second configuration and can be generated into a tangible physical object and/or into an object identification and/or pass code. For example, at step 302, at least some information affiliated with a virtual object in a first configuration can be stored in processor readable memory that can be accessed and/or processed by a processor affiliated with object transforming system 100 and at least some information affiliated with the virtual object can be transmitted via a communication portal to a user, via user device 102, and/or at least some information affiliated with a virtual object in a first configuration can be accessed by a user, via user device 102.

At step 304, a user can input a sequence of alpha-numeric inputs, such as, but not limited to, a persons name, a phrase, a word, a date, and/or any reasonable alpha-numeric input.

At step 306, a matching engine can affiliate various alpha-numeric information with various shape transformation information and/or various color transformation information such that based on the user's input sequence of alpha-numeric inputs the virtual object can transform from a first configuration to a second configuration. For example, the user's alpha-numeric inputs can be stored in a user input alpha-numeric input library and/or affiliated with stored information in alpha numeric input library 205, shape transformation library 201, and/or color transformation library 203 such that object transforming system 100 can access the stored user inputs and/or information causing the virtual object to transform from a first configuration to a second configuration.

At decision step 312, in a second configuration the virtual object can be produced as a tangible physical object, at step 314, and/or can be produced as a virtual object identification, at step 322. If a tangible physical object is desired, at step 314, object generating system 104 can generate the tangible physical object in the second configuration.

At step 316, the tangible physical object can be communicated and/or made available to a user such that the user can utilize the tangible physical object. At decision step 318, or decision step 312, the user can select to produce an object identification and/or pass code from the virtual object in the second configuration, at step 322.

The object identification can be any reasonable form of identification and/or pass code and can have encryption information affiliated with it. At step 324, the identification can be communicated and/or made available to a user such that the user can utilize the identification If the user has not already done so, similar to above, at decision step 326, or decision step 312, the user can select to generate the tangible physical object from the virtual object in the second configuration, at step 314. After producing the object identification and/or producing a tangible physical object the user can elect to quit and/or end the process, at step 320.

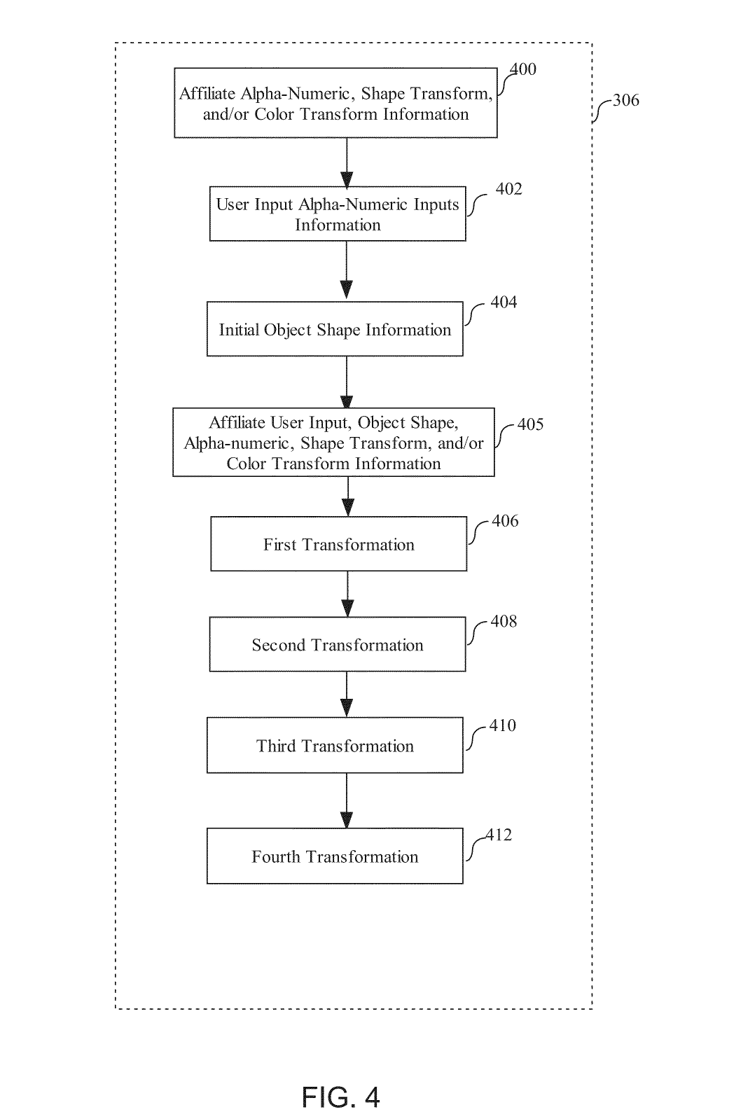

Referring to FIG. 4, in exemplary embodiments, an algorithm can be applied by a matching engine, at step 306 described above, that affiliates various alpha-numeric information with various shape transformation information and/or various color transformation information such that based on the user's alpha-numeric inputs the virtual object can transform from a first configuration to a second configuration.

More specifically, at step 400, a matching engine may use an algorithm that affiliates user input alpha-numeric inputs to a shape and/or color transformation using alpha-numeric information, shape transformation information, and/or various color transformation information. For example, referring back to FIGS. 2A-2C, each shape transformation information 201, each color transformation information 203, and/or each alpha-numeric information 205 can be affiliated such that object transforming system 100 can use the affiliated information to change the shape and/or color of an object based on each sequential alpha-numeric inputs received from a user.

At step 402, each alpha-numeric user input can be stored in at least one processor readable memory and/or can be accessed and/or processed by at least one processor affiliated with object transforming system 100, user electronic device 102, and/or object generating system 104. By way of example, referring to FIGS. 5A and 6A, a user input alpha-numeric input phrase “T-I-M-E” can be stored in at least one processor readable memory and/or can be accessed and/or processed by at least one processor affiliated with object transforming system 100, user electronic device 201, and/or object generating system 104. By way of another example, referring to FIGS. 5B and 6B, a user input alpha-numeric phrase “E-M-I-T” can be stored in at least one processor readable memory and /or can be accessed and/or processed by at least one processor affiliated with object transforming system 100, user electronic device 102, and/or object generating system 104.

At step 404 of FIG. 4, at least some information affiliated with an objects initial shape can be stored in at least one processor readable memory and/or can be accessed and/or processed by at least one processor. By way of example, referring to FIGS. 5A and 5B a cuboid shaped object 502, and referring to FIGS. 6A and 6B a cylindrical shaped object 602, can be stored in at least one processor readable memory such that it can be accessed and/or processed by at least one processor affiliated with object transforming system 100, user electronic device 102, and/or object generating system 104 at step 404. It will be understood that other shapes can be used. For ease, at times, not all variations of shapes are discussed. This is merely for ease and is in no way meant to be a limitation.

At step 405 of FIG. 4, in exemplary embodiments, at least some information affiliated with each of the user input alpha-numeric inputs, the object initial shape, and/or the affiliated alpha-numeric input, shape transformation, and/or color transformation, stored in at least one processor readable memory, can be accessed by at least one processor affiliated with object transforming system 100 such that each of the user's input alpha-numeric inputs can be affiliated with a shape transformation and/or color transformation for the object.

At steps 406-412 of FIG. 4, each of the user's input alpha-numeric inputs affiliated with shape transformations and/or color transformations for the object can be sequentially and/or cumulatively applied. For example, for four (4) alpha-numeric inputs, the first shape/color transformation can be the shape/color transformation for the first alpha-numeric input; the second shape/color transformation can be the shape/color transformation for the second alpha-numeric input applied against the result of the first shape/color transformation; the third shape/color transformation can be the shape/color transformation for the third alpha-numeric input applied against the result of the second shape/color transformation; and the fourth shape/color transformation can be the shape/color transformation for the fourth alpha-numeric input applied against the result of the third shape/color transformation.

By way of example, referring to FIG. 5A, for a user input alpha-numeric phrase “T-I-M-E” the first user input alpha-numeric input “T” 506, which affiliates with alpha-numeric information 205′ and color transformation 203′ and shape transformation 201′, causing shape transformation 508 and no color change 510 for the object (i.e., color remains the “same”), at step 406. The result of the first transformation can then undergo a second transformation based on the second user input alpha-numeric input “I” 512, which affiliates with alpha-numeric information 205″ and color transformation 203″ and shape transformation 201″, causing shape transformation 514 and no color change 516 for the object, at step 408. Next, the result of the second transformation can then undergo a third transformation based on the third user input alpha-numeric input “M” 518, which affiliates with alpha-numeric information 205′″, color transformation 203′″, and shape transformation 201′″, causing shape transformation 520 and no color change 522 for the object, at step 410. Lastly, the result of the third transformation can then undergo a fourth transformation based on the fourth user input alpha-numeric input “E” 524, which affiliates with alpha-numeric transformation 205″″, color transformation 203″″, and shape transformation 201″″, causing shape transformation 526 and color change 528 for the object, at step 412.

In exemplary embodiments, the order of the alpha-numeric inputs can effect the outcome of various transformations because, for example, the transformation can be cumulative. For example, the transformation of an object using a user input alpha-numeric phrase “T-I-M-E” may be different than a user input alpha-numeric phrase “E-M-I-T”.

By way of example, referring to FIG. 5B, for a user input alpha-numeric phrase “E-M-I-T” the first user input alpha-numeric input “E” 536, which affiliates with alpha-numeric transformation 205″″, color transformation 203″″, and shape transformation 201″″, causing shape transformation 538 and no color change 540 for the object, at step 406. The result of the first transformation can then undergo a second transformation based on the second user input alpha-numeric input “M”, which affiliates with alpha-numeric information 205′″, color transformation 203′″, and shape transformation 201′″, causing shape transformation 544 and no color change 546 for the object, at step 408. Next, the result of the second transformation can then undergo a third transformation based on the third user input alpha-numeric input “I”, which affiliates with alpha-numeric information 205″ and color transformation 203″ and shape transformation 201″, causing shape transformation 550 and no color change 552 for the object, at step 410. Lastly, the result of the third transformation can then undergo a fourth transformation based on the fourth user input alpha-numeric input “T” 554, which affiliates with alpha-numeric information 205′ and color transformation 203′ and shape transformation 201′, causing shape transformation 556 and color change 558 for the object, at step 412.

In exemplary embodiments, the shape of the initial object can be any geometric shape, such as, but not limited to, cuboid as shown in FIG. 5, columnar as shown in FIG. 6, and/or any reasonable geometric shape such as, but not limited to, polyhedronal, spherical, cylinder, conical, truncated cone, prisms, any combination or separation thereof, and/or any other geometric shape and/or any other reasonable shape.

In exemplary embodiments, the shape of the initial object can affect the outcome of various transformations. By way of example, referring to FIG. 6A, for a user input alpha-numeric phrase “T-I-M-E” the first user input alpha-numeric input “T” 606, which affiliates with alpha-numeric information 205′ and color transformation 203′ and shape transformation 201′, causing shape transformation 608 and no color change 610 for the object, at step 406. The result of the first transformation can then undergo a second transformation based on the second user input alpha-numeric input “I” 612, which affiliates with alpha-numeric information 205″ and color transformation 203″ and shape transformation 201″, causing shape transformation 614 and no color change 616 for the object, at step 408. Next, the result of the second transformation can then undergo a third transformation based on the third user input alpha-numeric input “M” 618, which affiliates with alpha-numeric information 205′″, color transformation 203′″, and shape transformation 201′″, causing shape transformation 620 and no color change 622 for the object, at step 410. Lastly, the result of the third transformation can then undergo a fourth transformation based on the fourth user input alpha-numeric input “E” 624, which affiliates with alpha-numeric transformation 205″″, color transformation 203″″, and shape transformation 201″″, causing shape transformation 626 and color change 628 for the object, at step 412.

Further, in exemplary embodiments, the shape and/or the order of the alpha-numeric inputs can effect the outcome of various transformations. By way of example, referring to FIG. 6B, for a user input alpha-numeric phrase “E-M-I-T” the first user input alpha-numeric input “E” 636, which affiliates with alpha-numeric transformation 205″″, color transformation 203″″, and shape transformation 201″″, causing shape transformation 638 and no color change 640 for the object, at step 406. The result of the first transformation can then undergo a second transformation based on the second user input alpha-numeric input “M” 642, which affiliates with alpha-numeric information 205′″, color transformation 203′″, and shape transformation 201′″, causing shape transformation 644 and no color change 646 for the object, at step 408. Next, the result of the second transformation can then undergo a third transformation based on the third user input alpha-numeric input “I” 648, which affiliates with alpha-numeric information 205″ and color transformation 203″ and shape transformation 201″, causing shape transformation 650 and no color change 652 for the object, at step 410. Lastly, the result of the third transformation can then undergo a fourth transformation based on the fourth user input alpha-numeric input “T” 564, which affiliates with alpha-numeric information 205′ and color transformation 203′ and shape transformation 201′, causing shape transformation 656 and color change 658 for the object, at step 412.

In exemplary embodiments, the initial virtual object can based on any reasonable object such as, but not limited to, an arbitrary geometrically shaped object, artwork, a commercial object, consumer electronic device, key fob, picture frame, household item, and/or any object capable of having a virtual object based on it. In further exemplary embodiments, the initial virtual object can be based on or actually be a virtual object, such as, but not limited to, an avatar, an object affiliated with a user, and/or any reasonable virtual object.

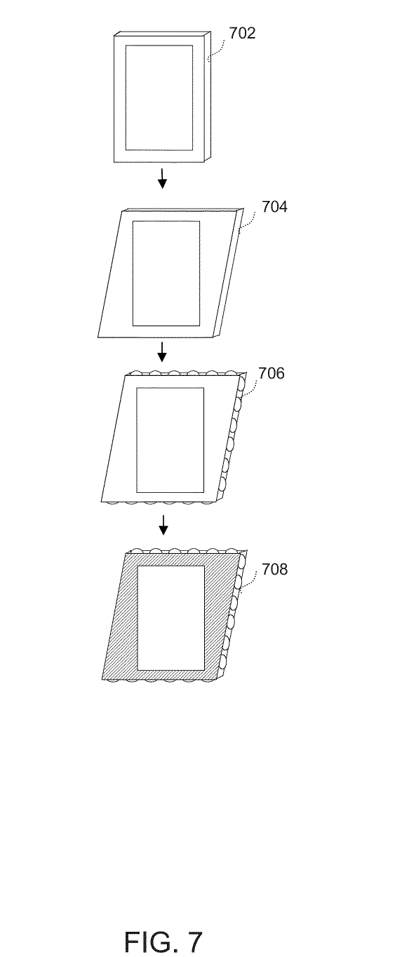

For example, referring to FIG. 7, a virtual shell of a mobile phone based on the required dimensions of a real mobile phone shell can be used to generate a new mobile phone shell in a second configuration that can be used to replace the original mobile phone shell. Similar to above, the shell of a mobile phone can undergo a plurality of transformations, for example, starting as an initial object 702, undergoing a first transformation 704, a second transformation 706, and a final transformation 708. It will be understood that any quantity of transformation can occur. For ease, at times, only three or four transformation are discussed. This is merely for ease and is in no way meant to be a limitation.

In exemplary embodiments, objects can be transformed and/or generated such that they are personalized to an individual, a company, and/or to provide reference to a phrase, date, and/or any other alpha-numeric input.

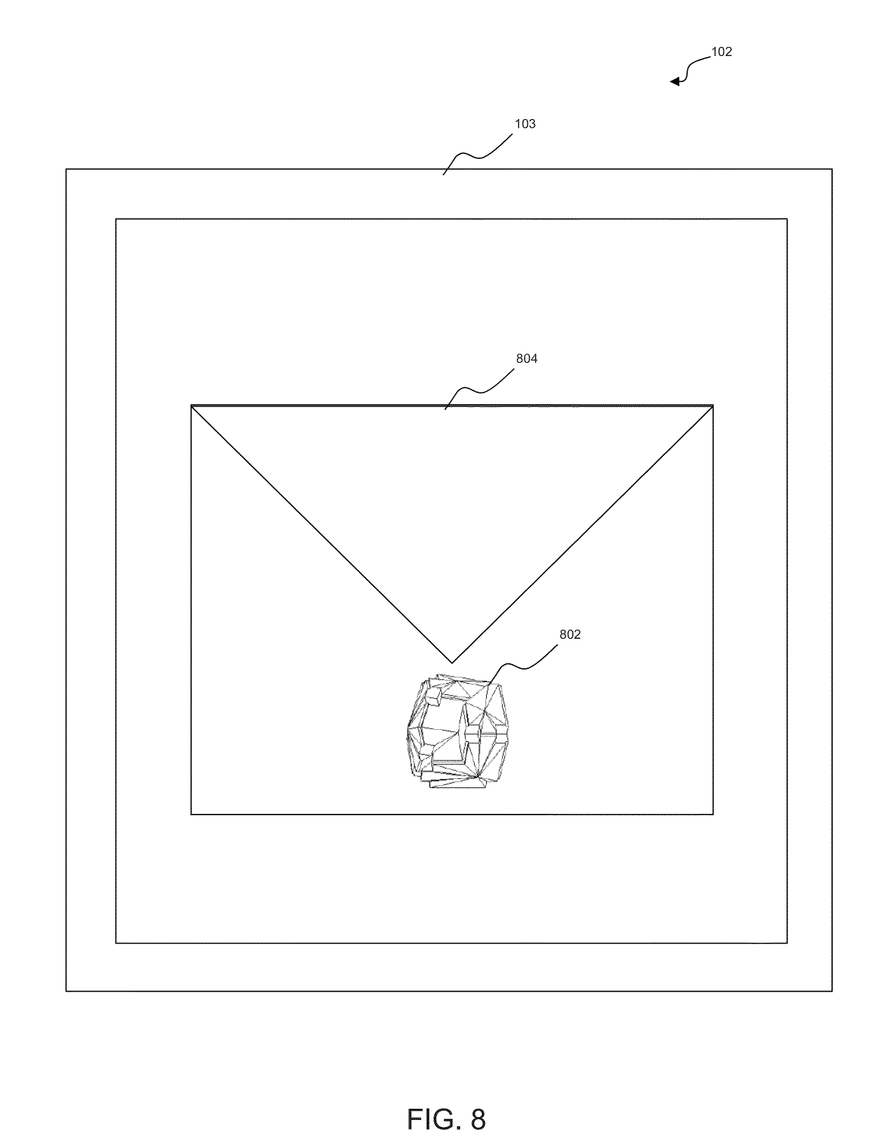

Referring to FIG. 8, in exemplary embodiments, the virtual object in a second configuration can be used as identification. For example, as shown, virtual object 802 is shown with an incoming email 804 on a graphical user interface 103 of user device 102 notifying the recipient that the email is from Tim. As another example, a user can use a virtual object affiliated with them as a pass code for entrance to a website, as a symbol of their name, as a symbol affiliated with a corporation, and/or any reasonable form of identification.

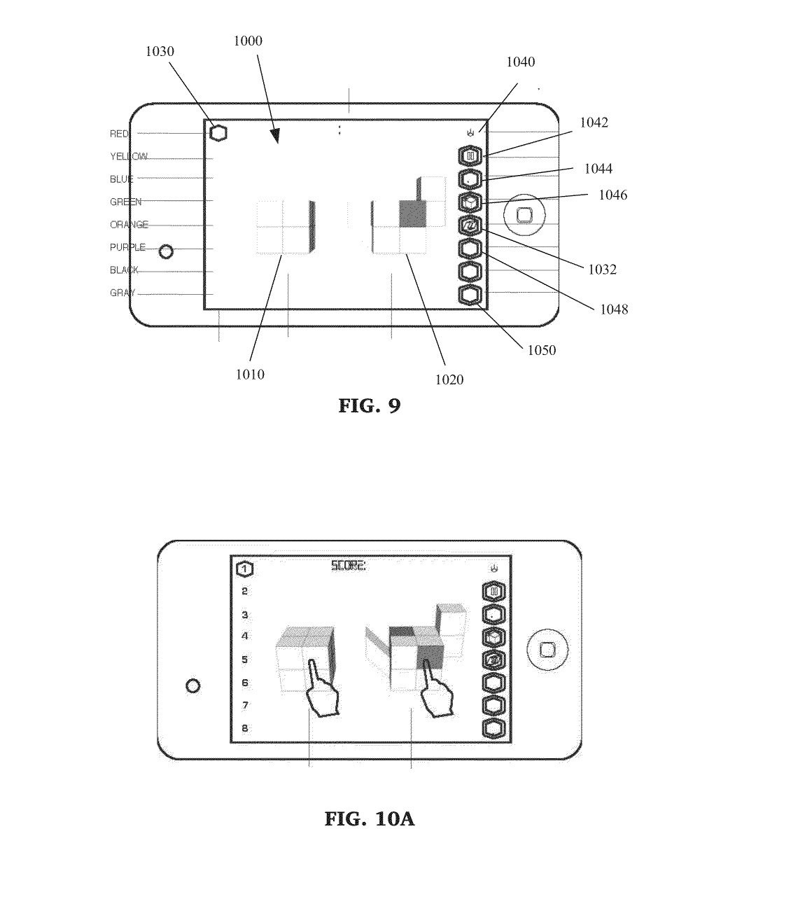

FIG. 9 is a screenshot of an electronic game using the systems and methods of the various exemplary embodiments of the present invention. In general, the game challenges a user to match an initial object to a target object by allowing the user to transform the initial object in a series of steps. Game play can be scored based on, for example, the number of steps and/or the amount of time used to match the objects, with a better score being given for matching the objects in lesser time and/or using fewer steps. The initial object may be of any geometric shape, such as, but not limited to, cuboid as shown in FIG. 9, polyhedronal, spherical, cylinder, conical, truncated cone, prisms, any combination or separation thereof, and/or any other geometric shape and/or any other reasonable shape. In the exemplary embodiment shown in FIG. 9, the game is implemented on a mobile device, such as, for example, iPod®, iPhone®, smartphone, and BlackBerry®, to name a few. Accordingly, the game may utilize the touchscreen capabilities of such devices to allow the user to, for example, spin, rotate, translate and otherwise manipulate the initial object for better viewing, change the color of the initial object and/or individual features of the initial object, and alter the shape of the initial object by adding to, removing from and/or modifying the initial object and/or individual features of the initial object, to name a few.

As shown in FIG. 9, the game interface 1000 according to an exemplary embodiment of the present invention displays an initial object 1010 and a target object 1020. The game interface 1000 may also display transformation tools, such as, for example, a color transformation tool 1030 that allows a user to change the color of one or more features of the initial object 1010. The color transformation tool 1030 may include an array of colored symbols, where each symbol may be colored, for example, red, yellow, blue, green, orange, purple, black or gray. The color of an object feature may be changed by touch-selecting the object feature and then touch-selecting one of the symbols corresponding to a chosen color for that object feature. The game interface 1000 may also provide a skew transformation tool 1032 that allows a user to skew the shape of an initial object feature. For example, the initial object feature may be skewed so as to angle to the left, to the right, backwards or forwards or some other direction. Features of the initial object may be extended by touch-selecting a feature (e.g., a square), and dragging the feature in a desired direction. The extension of the feature may be in predetermined incremental lengths, such as, for example, 1 cm or some other amount. It should be appreciated that the number and types of transformation tools is not limited by the description provided herein. For example, rather than color coded symbols, the color transformation tool 1030 may include function keys each coded with numbers and/or letters that correspond to a particular color, or the symbols may be color-coded and be coded with numbers and/or letters.

The game interface 1000 may include other buttons, widgets, controls, displays, etc., such as, for example, a homescreen button 1040, a pause button 1042, a timer 1044, a foreground view toggle switch 1046, a level indicator 1048 and a help/feedback button 1050.

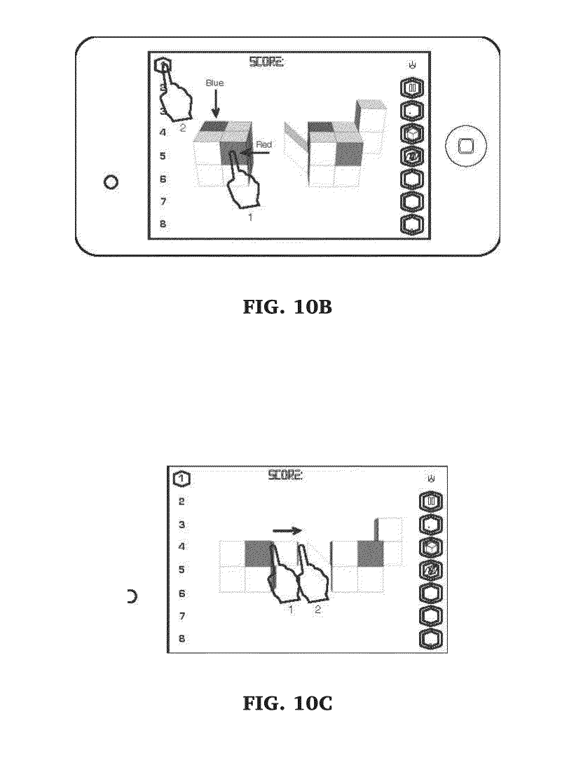

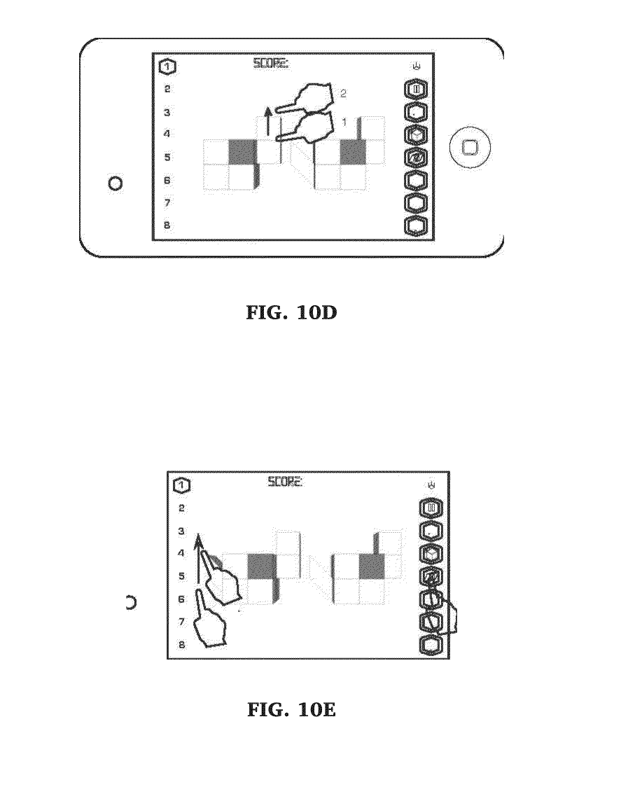

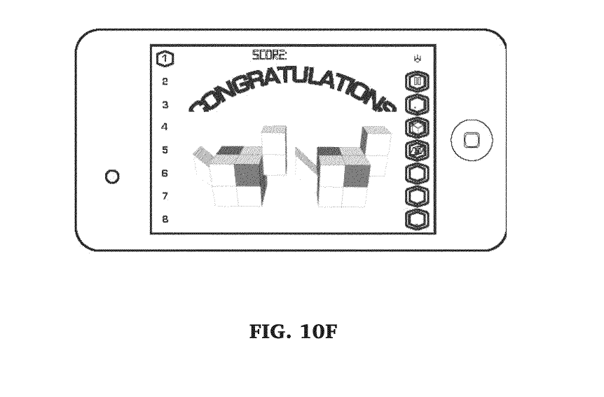

FIGS. 10A-10F show the game interface 1000 according to an exemplary embodiment of the present invention as implemented on a mobile device as a player manipulates an initial object to match a target object within the interface. As shown in FIG. 10A, the target object 1020 may be displayed as a continuously spinning object so that the player can completely view the various features of the target object 1020. In an exemplary embodiment, the player may be able to touch-select the target object 1020 to stop it from spinning, drag the object to rotate it in a particular direction, and/or swipe the object to cause it to spin in a particular direction. Similarly, the initial object 1010 may also be spun, rotated or stopped using the touchscreen capabilities of the mobile device.

As shown in FIG. 10B, the color of a square within the initial object 1010 may be changed by the user by first touch-selecting the square and then touch-selecting one of the colored symbols within the color transformation tool 1030.

As shown in FIG. 10C, one of the squares within the initial object 1010 may be extended by touch-selecting the square and dragging it in a chosen direction. In this case, dragging the square results in a duplicate square “snapping” out an incremental distance from the initial square. However, it should be appreciated that in other embodiments an initial object feature may be extended by any amount not limited by a specific increment.

As shown in FIG. 10D, the square extended in FIG. 10C may be further extended using the previously-described technique.

As shown in FIG. 10E, another square may be extended and then skewed using the skew transformation tool 1032. Skewing may be achieved by the user first touch-selecting the skew transformation tool 1032, touch-selecting the object feature to be skewed, and then dragging the feature in the direction that the feature is to be skewed.

As shown in FIG. 10F, after the player has transformed the initial object in the appropriate manner, the player is notified that the initial object matches the target object. The player's final score may be displayed within the game interface 1000. A new level of game play may then begin, with the new level having increased difficulty. For example, the new level may include a more complex target object.

It should be appreciated that the game interface 1000 may be implemented on other types of electronic devices, such as, for example, desktop computers, laptops, iPads®, and other portable computing devices. In this regard, user input through the game interface 1000 may be achieved through any number and type of devices, such as, for example, joysticks, gamepads, paddles, trackballs, steering wheels, pedals, light guns, or other types of game controllers, to name a few. In other exemplary embodiments, user input through the game interface 1000 may be achieved through a keyboard having a standard keyboard layout, such as QWERTY, or a specialized keyboard having, for example, colored keys corresponding to colors to be applied to an object feature, one or more skew keys corresponding to directions of skew, one or more extension keys corresponding to direction and/or amount that an object feature is to be extended, and other object transformation keys as desired or appropriate.

In an exemplary embodiment, the electronic game may have a free play mode in which the initial object can be transformed freely without any reference to a target object. Once the user is satisfied with the transformation of the initial object to a final object design, an object generating system may then be used to create a physical representation of the virtual object, as previously discussed. The object generating system may be affiliated with and/or an element of a rapid production device such as, but not limited to, a 3-D printing system, direct metal laser sintering system, selective laser sintering system (“SLS”), fused deposition modeling system (“FDM”), stereolithography system (“SLA”), laminated object manufacturing system (“LOM”), and/or any technique and/or system that can produce a tangible physical structure.

In an exemplary embodiment, at the conclusion of a particular game level, the game may offer the player the option of ordering a physical representation of the matched virtual object. The physical representation may be pre-fabricated, or fabricated when the player opts to order the physical representation.

Now that exemplary embodiments of the present disclosure have been shown and described in detail, various modifications and improvements thereon will become readily apparent to those skilled in the art.

What is claimed is:

1. A method, comprising:
displaying on an input device an initial virtual object and a target virtual object;
receiving by the input device user input information related to transformation of one or more characteristics of the initial virtual object;
transforming, using one or more processors, the one or more characteristics of the initial virtual object from a first configuration to a second configuration based on the user input information;
displaying on the input device the initial virtual object with the transformed one or more characteristics as a modified initial virtual object; and
determining, using one or more processors, whether the modified initial virtual object matches the target virtual object.

2. The method of claim 1, wherein the input device comprises a graphical user interface.

3. The method of claim 1, wherein the graphical user interface comprises one or more widgets selected from the group consisting of: buttons, check boxes, radio buttons, sliders, list boxes, spinners, drop-down lists, menus, menu bars, toolbars, ribbons, combo boxes, icon, tree views, grid views, cover flows, tabs, scrollbars, text boxes, labels, tooltips, balloon help, status bars, progress bars, and infobars.

4. The method of claim 1, wherein the input device comprises a game controller.

5. The method of claim 1, wherein the game controller comprises one or more game controller types selected from the group consisting of: joysticks, gamepads, paddles, trackballs, steering wheels, pedals, and light guns.

6. The method of claim 1, wherein the one or more characteristics are selected from the group consisting of: shape, color, material properties, texture, and mechanical properties.

7. The method of claim 1, further comprising:
generating, using at least one object generating system, a tangible physical object based on the modified initial virtual object.

8. The method of claim 7, wherein the tangible physical object is generated using at least one of stereo-lithography, 3-D printing, and direct laser sintering.

9. The method of claim 1, wherein at least one of the target virtual object or the initial virtual object has a three-dimensional shape.

10. The method of claim 1, wherein the input device comprises a type of input device selected from the group consisting of: desktop computers, laptop computers, smartphones, tablet computers, mobile phones and personal digital assistants.

11. A system, comprising:
at least one processor;
at least one processor readable medium operatively connected to the at least one processor, the at least one processor readable medium having processor readable instructions executable by the at least one processor to perform the following method:
displaying on an input device an initial virtual object and a target virtual object;
receiving by the input device user input information related to transformation of one or more characteristics of the initial virtual object;
transforming, using one or more processors, the one or more characteristics of the initial virtual object from a first configuration to a second configuration based on the user input information;
displaying on the input device the initial virtual object with the transformed one or more characteristics as a modified initial virtual object; and
determining, using one or more processors, whether the modified initial virtual object matches the target virtual object.

12. The system of claim 11, wherein the input device comprises a graphical user interface.

13. The system of claim 11, wherein the graphical user interface comprises one or more widgets selected from the group consisting of: buttons, check boxes, radio buttons, sliders, list boxes, spinners, drop-down lists, menus, menu bars, toolbars, ribbons, combo boxes, icon, tree views, grid views, cover flows, tabs, scrollbars, text boxes, labels, tooltips, balloon help, status bars, progress bars, and infobars.

14. The system of claim 11, wherein the input device comprises a game controller.

15. The system of claim 11, wherein the game controller comprises one or more game controller types selected from the group consisting of: joysticks, gamepads, paddles, trackballs, steering wheels, pedals, and light guns.

16. The system of claim 11, wherein the one or more characteristics are selected from the group consisting of: shape, color, material properties, texture, and mechanical properties.

17. The system of claim 11, further comprising:
generating, using at least one object generating system, a tangible physical object based on the modified initial virtual object.

18. The system of claim 17, wherein the tangible physical object is generated using at least one of stereo-lithography, 3-D printing, and direct laser sintering.

19. The system of claim 11, wherein at least one of the target virtual object or the initial virtual object has a three-dimensional shape.

20. The system of claim 11, wherein the input device comprises a type of input device selected from the group consisting of: desktop computers, laptop computers, smartphones, tablet computers, mobile phones and personal digital assistants.
